(19) United States
(12) Patent Application Publication
(10) Pub. No.: US 2011/0062250 A1
(43) Pub. Date: Mar. 17, 2011

(54) FLAME EFFECT GENERATOR

(76) Inventors: Martin Betz, Co. Louth (IE); Noel O'Neill, Co. Louth (IE); Wolfram Fischer, Co. Louth (IE); Gareth Murray, Co. Louth (IE)

(21) Appl. No.: 12/993,707

(22) PCT Filed: May 22, 2009
(86) PCT No.: PCT/EP2009/056254

§ 371 Date: Dec. 6, 2010

(30) Foreign Application Priority Data
May 22, 2008 (GB) 0809322.1

(51) Int. Cl. B05B 1/08; B05B 1/00

(52) U.S. Cl. 239/102.1; 239/211

(57) ABSTRACT

A flame effect generator that operably uses a liquid reservoir to provide liquid for use in generation of flame effects is described.

### FIELD OF THE INVENTION

The present invention relates to electric fires and particularly to electric fires that simulate flame effects. The invention more particularly relates to a flame effect generator that may be used within the context of electric fires to generate flame effects that are viewable within the fire. The invention in another aspect also relates to a fire having a reservoir for use in generation of flame effects which is also used for secondary features of the fire. The invention also provides in a further aspect relates to an integrated water cooler and electric fire. In yet a further aspect a fuel bed with a pocket for receiving one or more electronic controls is provided. Yet a further aspect provides a voice actuated electric fire. One or more of these aspects can be used in combination with other aspects or could be used independently of the others.

### BACKGROUND

Electric fires are well known and have been used for many years to generate flame and/or fuel effects which simulate the burning of a real fire. Such fires may be used as a source of heat within the environment where they are provided or indeed may have no actual heat source but are used to generate a focal point.

Recent developments by the present patentee have provided electric fires that use water vapour or mist to generate the effects of flames within the housing of the fire. Such fires are particularly advantageous in that a three dimensional flame effect is provided which substantially mimics the behaviour one would expect from a real flame. Despite these advantages there are requirements for improvements in such flame generators.

### SUMMARY

These and other problems are addressed by a flame generator in accordance with the teaching of the present invention. Such a flame generator includes a mist generator wherein a mist may be generator. The generated mist is then distributed to a mist reservoir or distribution channel, the mist reservoir having an entrance in communication with the mist generator and through which a generated mist may pass. The mist reservoir also provides an outlet from which mist may then be allowed to pass upwardly into the fire within which the generator is located. The mist reservoir may be integrally formed or separate from the mist generator. It is desirable that such a flame generator would be provided in a lower portion or region of a fire housing and that the outlet from the mist reservoir would allow the generated mist to pass into the fire at a location coincident with the location of a fuel bed provided within the fire.

Desirably the mist generator uses a liquid from which the mist is generated. This liquid could be agitated through use of an ultrasonic generator or the like to effect the formation of fine particles of mist which then pass into the mist reservoir. To ensure that an adequate supply of mist may be provided it is desirable that the mist generator is in fluid communication with a liquid reservoir. Such a reservoir could be provided as a separate removable container from the flame generator so as to allow for separation of the liquid reservoir from the flame generator to allow for ease of refilling of the liquid reservoir. In a preferred arrangement the liquid reservoir is coupled to the mist generator via a top mount arrangement, control of flow of liquid from the liquid reservoir into the mist generator being effected by use of a valve arrangement or the like. If provided such a valve arrangement would desirably be of the type known as plunge valve which enables liquid—typically water—flow, once the reservoir is seated on the mist generator. Once seated the liquid will then pass from the liquid reservoir to the mist generator under gravity—the levels in each of the two vessels being maintained through the head pressure operating against the volume in each of the two vessels.

Desirably the mist generator will also include a level indicator or switch that will be operable on the ultrasonic transducer to ensure that if the liquid level within the generator falls below a predetermined minimum level that the transducer will be turned off to preserve the operating lifetime of the transducer. Such a level indicator could, in a modified arrangement, be operable on a valve between the liquid reservoir and the mist generator to control the flow of liquid between the two to ensure that an optimum supply of liquid is maintained within the mist generator during operation. The level indicator or switch may also be coupled to an external visible indicator which is located within the fire housing so as to be visible to a user of the fire to advise when the level of the liquid has reached levels that require replenishing of the liquid reservoir.

The mist generator desirably includes mist generating means. As was mentioned above one example of the type of mist generating means that may be used is an ultrasonic transducer. Desirably two or more transducers are used within the mist generators. The operation of each of the multiple transducers may be provided in a controlled fashion such that additional generation of vapour may be created by turning on more of the transducers than during other times. In another arrangement the control could provide for alternative operation of the multiple transducers to extend the lifetime of any one of the provided transducers. It will be appreciated that similarly to any other electronic equipment that transducers have a lifetime operation period. By activating selected ones of the provided transducers in a sequence while at the same time deactivating selected others of the transducers it is possible to prolong the lifetime operation of the flame generator. Other benefits of having selective activation of one or more of a provided plurality of transducers is that the flame effect generated could be changed as desired. For example, it will be appreciated that the transducers are displaced relative to one another within the mist generator. If transducers in a first region are activated and others in a second region are not, then the volume of mist generated and the density of resultant flames viewed will be greater at that first region than the second. Such selection may be provided by control circuitry for the transducers provided within an electronics housing portion of the flame generator.

Where provided, it is desirably that the electronics housing portion provides for adequate distribution of heat away from the electronics components within the housing. Desirably this is provided by locating the electronics housing portion in a lower region of the flame generator and providing its base or floor as a metallic or other suitable heat conducting material. In this way the heat generated by the electronic circuitry may be effectively distributed away from the circuitry by the heat sink provided by the floor.

Other electrical components or circuitry for example, power supplies or other similar components that require high voltages are desirably provided in a region of the fire that is separate from that of the flame generator. Typically this may be provided by locating the flame generator to the front of the fire housing and the other fire electronics to the rear of the housing. Such electronics could be mounted at a height higher than that of the flame generator such that in scenarios where there was a leak from the flame generator that such leaked water would not ingress onto the electronics causing a short or the like. Typically access to this electronics will be affected via a separate access panel to that used to access the flame generator—the access panel for the electronics desirably being provided in a rear portion of the fire housing.

Desirably each of the components that form the flame generator are provided in modular co-operable components which when assembled provide for fluid communication of a liquid initially provided in the liquid reservoir through an outlet thereof into the mist generator where a mist may be fabricated and then into the mist reservoir or distributor from which it may exit the flame generator. By providing each of the components as separate elements it is possible to easily assemble the respective components. By having a separate liquid reservoir it is possible to easily transport the reservoir by itself to a liquid source for replenishment. By having the distributor or reservoir formed separately to the mist generator it is possible to enable removal of the mist reservoir so as to gain access to the mist generator for example for cleaning or maintenance purposes. All may then be mated together in a modular engagement to provide a compact flame generator that may easily be fitted within available room of a fire housing. The distributor desirably provides a defined or sealed chamber with its exit aperture providing the sole route of escape of generated vapour from the flame generator. This is desirably along a channel defined in an axis substantially parallel to the front of the fire housing when the flame assembly is mounted therein. It will be appreciated however that the mist reservoir may provide multiple exits for distribution of generated mist into the fire housing and may also provide an arcuate distribution channel such that the exiting mist exits non-linearly.

To assist in mounting the flame generator to the fire housing it is desirably that the flame generator includes a shoe or template which defines a mating location for the flame generator within the housing. As will be appreciated the outlet from the flame generator determines where generated mist or vapour will exit and be introduced into the fire housing. To achieve the desired flame effects it is desirably that this is orientated correctly vis a vis respective light sources and/or fuel beds within the fire housing. By having a shoe or template that is permanently secured within the housing and with which the remainder of the flame generator may engage and mate, it is possible to ensure that each time the separate components of the flame generator are located back into the fire housing that they adopt their correct desired orientation. The shoe desirably defines a perimeter within which the other components of the flame generator are seated. The shoe may be secured within the housing of the fire and then the other components of the flame generator seated onto the shoe and maintained therein through use of clips or the like. Other arrangements or securing means for securing each of the shoe to the housing and the flame generator to the shoe could also be used, as will be appreciated by those skilled in the art.

Desirably the shoe will also include a heat sink that will co-operate with the heat sink (where provided) of the electronics housing to dissipate the heat further away from the electronic components of the flame generator. This may be coupled to a portion of the fire housing to sink the heat further.

Components of the flame generator that are intended to be in contact with a liquid are desirably manufactured from or treated with suitable anti-microbial agents to minimise any growth of unwanted microbes during the lifetime of the flame generator.

The flame generator may also include a fan or other mist agitator. If provided as a fan it is desirable that the fan has an entrance port external to the flame generator and from which it can draw air in and into contact with the mist to effect distribution of the mist out of the reservoir or distributor plate. Such a fan may direct the agitated air directly into the mist generator portion of the flame generator or may alternatively or as well direct it towards the mist reservoir portion.

Desirably the flame generator is mounted within a fire housing in a lower portion thereof such that mist or other vapour effects which exit from the flame generator pass upwardly into the housing of the fire where they will resemble flame effects. To provide for ease of access to the components of the flame generator it is desirable that at least one of the mounted flame generator and fire housing me moveable relative to the other. For example the flame generator could be provided on a moveable slide or tray from which it may be slid into and out of the interior portion of the fire housing. In another arrangement which could be used independently or as well as the moveable slide, a portion of the fire housing could be moveable relative to another portion of the fire housing to provide access to an interior portion of the fire. Such movement could for example be achieved by having a hinged or pivot arrangement between the two portions of the fire housing that are moveable relative to one another.

A fire incorporating a flame generator such as that hereinbefore described with usefully employ one or more light sources which may be directed onto the exiting mist from the flame generator to give the effects of flame. Desirably the light sources are orientated within the fire housing such that light output from them is orientated towards the front of the fire housing. The colours of the lights sources may be varied by use of different coloured lights, the use of filters or the like or indeed by using electronically controlled light sources whose output changes with changing control signals. To achieve the best flame pattern it has been found by the present inventors that the light sources are arranged behind the exiting mist from the flame generator such that they operably shine through the exiting mist when seen from the front of the fire.

A fire housing incorporating such lights and a flame generator may desirably include an air intake vent located, desirably below the lights, so as to promote generation of air currents upwardly within the fire housing which will assist in conveying the exiting mist from the flame generator upwardly within the fire housing. One or more vents could be provided in an upper, typically front, region of the fire—desirably at a height higher than the resultant flames that are generated by the flame generator to provide for assisted air currents towards the front of the fire. These natural air currents may be assisted or replaced by an induced air current which is mechanically provided by one or more fans located in lower and/or upper regions of the fire housing and configured to operably provide air current upwardly through a fuel bed and on which the generated vapour or mist will be carried.

As was just mentioned, desirably a fire housing incorporating such a flame generator may also include a fuel bed which provides for the simulation of fuel bed effects as would be found in a traditional fire. There are many way to fabricate such fuel beds. One way which may be particularly useful within the context of the present invention although it could be used with other types of electric fires is to provide the fuel bed from a plurality of fuel bed elements which are mounted relative to one another to resemble a stacked fuel bed. Desirably a fuel bed element that will ultimately be located towards the front of the fuel bed may include a pocket within which may be received a light source such as an LED indicator or the like and/or a receiver for remote control operation of the fire. By discretely locating such devices within a fuel bed element it is possible to control the fire and/or obtain information regarding the status of the fire without having to modify the fire housing to provide such mountings. As control electronics for such light sources/receivers could be suitably located within a lower portion of the fire—perhaps beside the flame generator if provided, then the use of the fuel bed element with a pocket is particularly advantageous as the fuel bed is immediately adjacent the location of the control electronics. In another arrangement for a fuel bed in accordance with this teaching, the fuel bed will be formed from a moulded structure having a base with fuel elements (wither integral with or provided separate thereon) on an upper surface thereof and the pocket could be defined within the base portion.

It is desirable within the context of a fire provided within the teaching of the present invention that any generated flame pattern defined by interaction between generated mist and light sources within the fire housing will occupy a central dominant portion of the fire. To ensure that the generated flame effects are visible to a viewer to the front of the fire the light sources could be directed forwardly and upwardly such that the heated air currents resultant from the light sources and on which the mist is conveyed are preferentially directed towards the front and top of the fire housing. This is particularly advantageous in the context of a stove fire arrangement where the generated flame pattern is within a defined enclosed volume of the stove fire housing. Air vents provided at a top, typically front, portion of such a stove generate convective currents which carry the generated vapour upwardly and to the front of the stove. The lights could be trained onto these air currents to improve the generated flame effects.

It is also possible to top light the flame pattern so as to change the effect of the generated flame pattern. By increasing the illumination, it will be appreciated that the flame pattern generated may be less visible to a user and as such if provided it is desirable that the use of the top light be user controllable so that the user can determine the desired effect. To accentuate the generated flame effect it is desirable if at least rear walls of the interior portion defining the flame pattern generating region be darkly coloured to provide contrast with the coloured elements that define the flame pattern. It will be appreciated that a flame effect generated in accordance with the teaching of the present invention relies on an interaction between generated vapour and coloured lighting. For that vapour that is passing upwardly within the fire, but not in the light path of the coloured light sources, this vapour will be maintained in its original colouring. By providing a white light in an upper region of the fire and directing that downwardly this non-coloured vapour will be less visible to the person viewing the flame pattern and as a result the generated flame pattern will be better defined. Furthermore the down-lighting may provide for accentuation of the features of a fuel bed provided below. It is desirable that the luminosity of the top light be less than that of the flame generating light sources.

It will be appreciated that a flame generator such as that employed within the context of the present invention advantageously uses an interaction between light and generated mist or other vapours in an entrained air current to create flame effects. To further improve the illusion of the flame effects it is possible to address some of the other sensory expectations of a user watching a real fire. For example by providing an essence having the properties associated with a burning fire—for example burning logs—into the liquid reservoir any created smells will be conveyed in the heated air currents within which the exiting mist is entrained and carried from the fire where they will be experienced by the user. If provided such olfactory devices could be alternatively be provided in alternative arrangement that may not rely on an interaction with the generated vapour to distribute smells about the location where the fire is positioned.

It will be appreciated that a fire provided in accordance with the teaching of the invention provides for location of a liquid reservoir within a fire housing. In an alternative arrangement to that described heretofore, such a reservoir could be used for a secondary purpose. One example of such a secondary purpose is to provide a secondary water based feature such as waterfall within the fire housing. The liquid from the reservoir could be used to provide liquid for the waterfall which could be arranged to fall in front of the flame generating region within the fire. In such circumstances the operation of the waterfall could be used as an alternative to the operation of the fire or indeed could be used to enhance the viewing experience of the flame effects generated behind the waterfall.

Another secondary use for such a reservoir could be the provision of an integrated water dispenser and fire. Water dispensers are well known as standalone units that are located within work environments for dispensing liquid as required. Typically they use a removable reservoir which is periodically displaced. In accordance with the teaching of an embodiment of the present invention such a reservoir could be used as a reservoir for a flame generator. A housing for the water dispenser could include a flame generating region located about the reservoir so as to hide the reservoir. As a flame generator that operates by using generated vapour can define a flame pattern along an arcuate path, it is possible to encapsulate the reservoir within a flame pattern. Of course, it will be appreciated that in this context of an integrated water dispenser and fire that the necessity to share the same reservoir is not essential, and that other flame generating means could be used instead of one based on a mist generator.

An embodiment of the present invention also provides for voice actuation or control of operation of an electric fire. By locating a voice receiver within the fire and pre-associating voice commands with specific operation modes of the fire it is possible to enable a user to control the fire using their voice alone. One location for the voice receiver is within the hood or canopy portion of the fire where the receiver could be coloured to match that of the surrounding hood and therefore not present a visible indicator of its location. Another possible location would be within a pocket of a fuel bed element—such as that described above as a suitable location for remote control circuitry.

These and other features provided in accordance with the teaching of the present invention will be understood with reference to the Figures which follow.

### BRIEF DESCRIPTION OF THE DRAWINGS

The present invention will now be described with reference to the accompanying drawings in which:

FIG. 1A is top view of a flame generator provided in accordance with an exemplary embodiment of the present invention.

FIG. 1B is a front view of the generator of FIG. 1A.

FIG. 1C is a perspective view of the flame generator of FIGS. 1A and 1B.

FIG. 1D is a section along the line YY-YY of FIG. 1B.

FIG. 1E is a section along the line P-P of FIG. 1B.

FIG. 2A is a perspective view from the front of a fire housing in the form of an inset fire.

FIG. 2B is a section through the fire of FIG. 2A.

FIG. 3A shows a fire housing in the form of a stove housing from a front view.

FIG. 3B is a section through the fire of FIG. 3A.

FIG. 4A is a perspective view from the front and side of a fire incorporating a waterfall.

FIG. 4B is an alternative example of such a fire.

FIG. 5 is an example of an integrated water dispenser and fire in accordance with an embodiment of the present invention.

FIG. 6A is an example of a fuel bed incorporating a pocket for receiving electronics in accordance with an embodiment of the present invention.

FIG. 6B is an example of how the pocket of FIG. 6A could be provided within a fuel bed element.

### DETAILED DESCRIPTION OF THE DRAWINGS

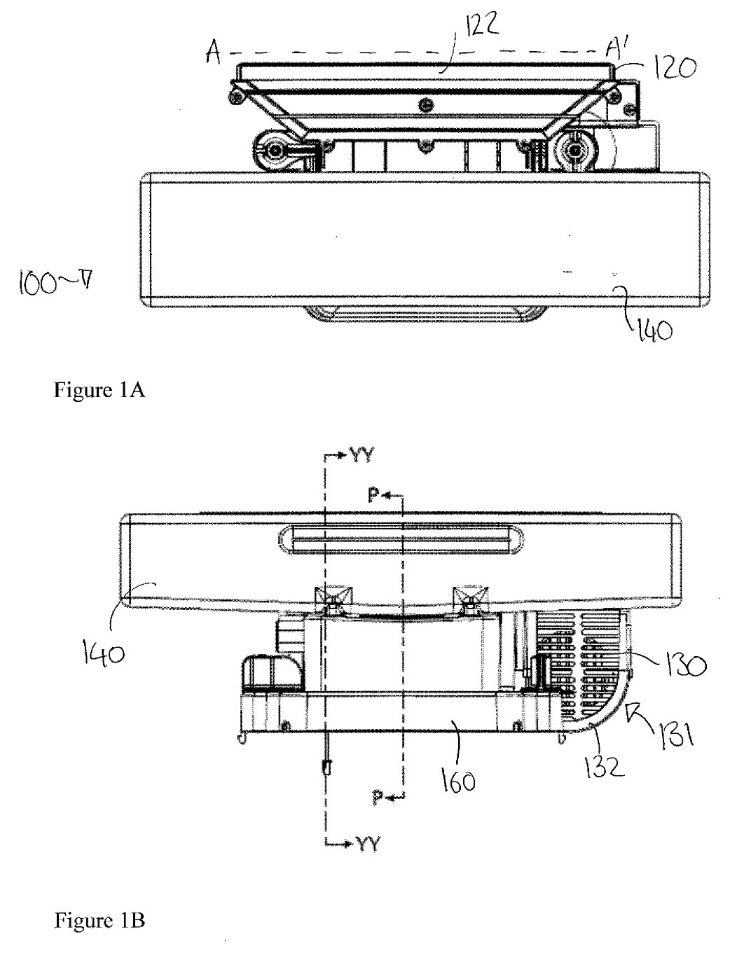

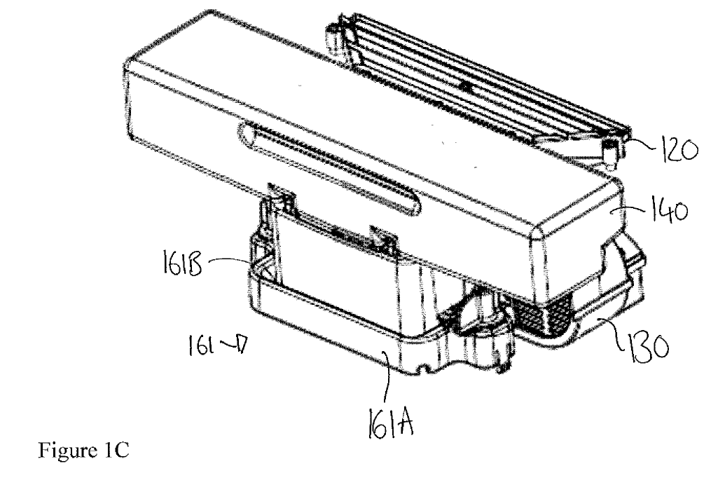

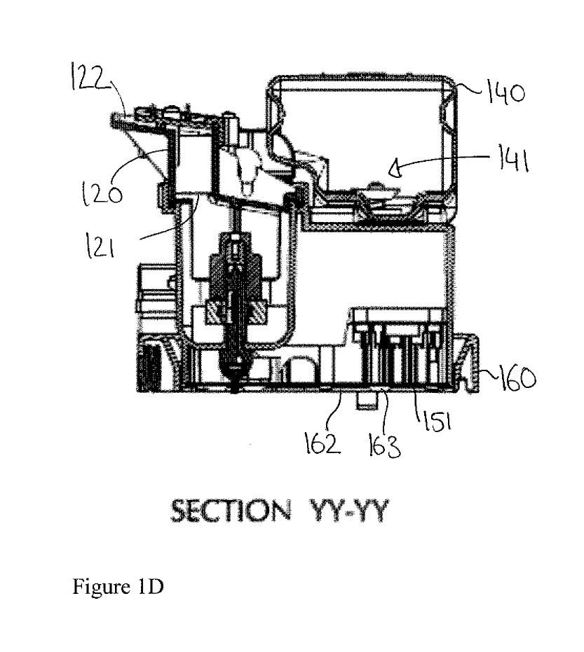

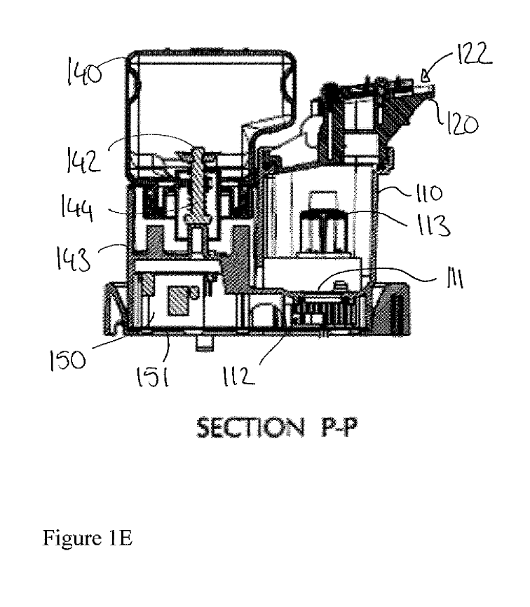

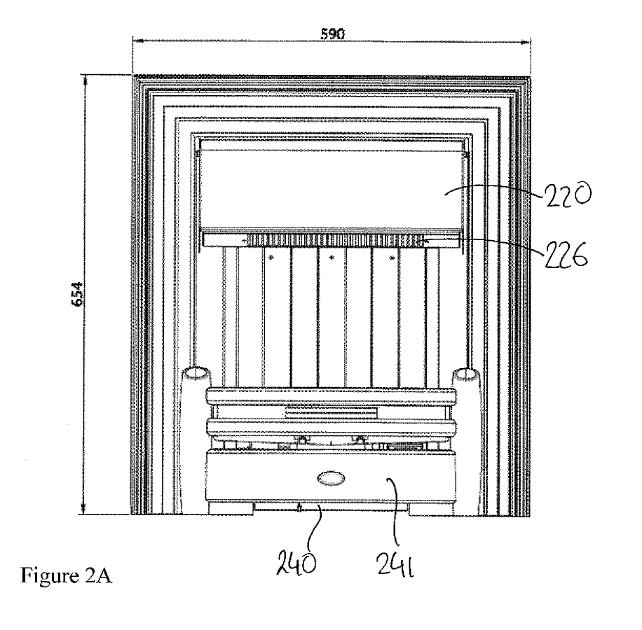

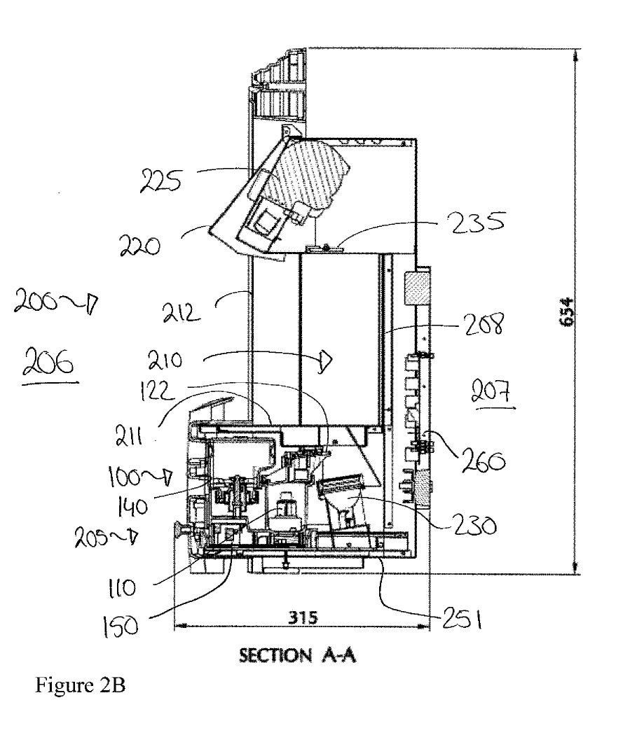

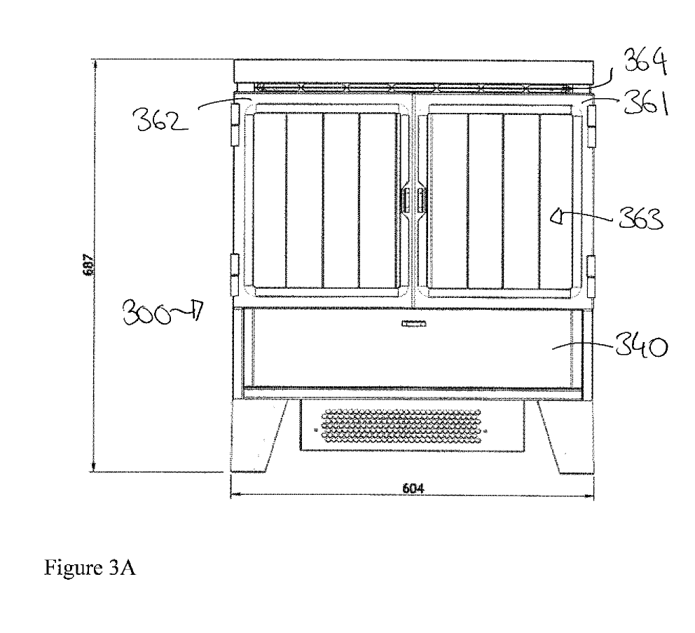

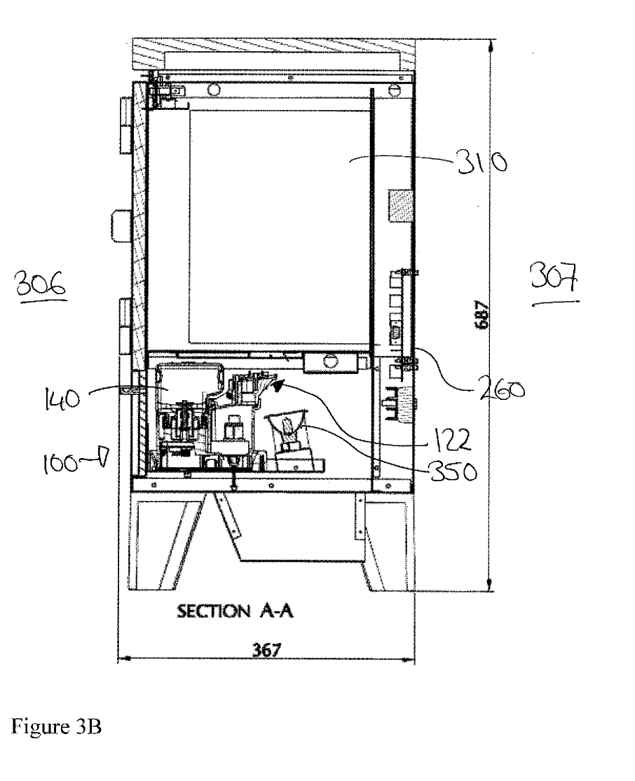

FIG. 1 shows an example of a flame generator 100 in accordance with the teaching of the present invention. Such a flame generator includes a mist generator 110 wherein operably a mist may be generated. The generated mist is then distributed to a mist reservoir 120 or distribution channel. The mist reservoir 120 has an entrance port 121 in communication with the mist generator and through which a generated mist may pass. The mist reservoir also provides an outlet 122 from which mist may then be allowed to pass upwardly into the fire within which the generator is located. As will be appreciated from an inspection of FIGS. 2 and 3, it is desirable that such a flame generator would be provided in a lower portion or region of a fire housing and that the outlet from the mist reservoir would allow the generated mist to pass into the fire at a location coincident with the location of a fuel bed provided within the fire. To this end it is desirable the flame generator be a sealed unit with only a predefined outlet path provided such that generated mist from the mist generator can exit into the fire only through a predefined exit—in this case the outlet channel 122 of the mist reservoir. While FIG. 1 shows a single linear exit it will be appreciated that multiple exits could be provided and that one or more of those exits could include an arcuate path.

Desirably the mist generator 110 uses a liquid from which the mist is generated. This liquid could be agitated through use of an ultrasonic generator 111 or the like to effect the formation of fine particles of mist which then pass into the mist reservoir. The ultrasonic transducer is typically provided in a base 112 or lower portion of the mist generator 110. In accordance with principles of ultrasonic transducers, the action of the ultrasonic transducer on a body of liquid with which it is in intimate contact causes the generation of microscopic particles of mist or vapour to be created on the surface of the liquid. The generated mist or vapour will pass upwardly into the reservoir or distribution channel 120 from which it will exit the flame generator. This may be assisted through use of a fan 130 but this will be discussed later. The distribution channel is desirably provides an extended outlet (A-A′) from the flame generator which when the flame generator 100 is located within a fire housing will extend along an axis substantially parallel with the front of the fire. In this way exiting vapour from the flame generator will be distributed across a wide area of a fuel bed within the fire such that simulated flames will appear to originate from all regions of the fuel bed.

To ensure that an adequate supply of mist may be provided it is desirable that the mist generator 110 is in fluid communication with a liquid reservoir 140. In the arrangement of FIG. 1, such a reservoir is provided as a separate removable container from the other components of the flame generator so as to allow for ease of refilling of the liquid reservoir. Liquid can be stored within an interior volume 141 of the reservoir. In the preferred arrangement shown, the liquid reservoir is coupled to the mist generator via a top mount arrangement, control of flow of liquid from the liquid reservoir into the mist generator being effected by use of a valve arrangement 142 or the like. If provided such a valve arrangement would desirably be of the type known as plunge valve which enables water flow once the reservoir is seated on the mist generator. As shown in FIG. 1E, the valve is provided in a lower portion of the liquid reservoir and when the reservoir 140 is seated on a receiver 143, a pin 144 which abuts against an inner surface 145 of the receiver 143 causes the valve to move upwardly so as to open a fluid communication path from the liquid reservoir into the mist generator. The liquid reservoir 140 is located above the mist generator so any liquid will pass downwardly under the effect of gravity.

As was mentioned above one example of the type of mist generating means within the mist generator that may be used is an ultrasonic transducer 111. Desirably two or more transducers are used within the mist generators but each of the provided transducers are used alternatively so as to extend the lifetime of any one of the provided transducers. These are typically arranged along a longitudinal axis of the mist generator, transverse to the section lines shown in FIG. 1B and parallel to the longitudinal axis of the distribution channel A-A′ shown in FIG. 1A. It will be appreciated that similarly to any other electronic equipment that transducers have a lifetime operation period. By activating selected ones of the provided transducers in a sequence while at the same time deactivating selected others of the transducers it is possible to prolong the lifetime operation of the flame generator. Such selection may be provided by control circuitry provided within an electronics housing portion of the flame generator. It will be appreciated that as each of the transducers act more efficiently on the head of liquid immediately above that the changes of operation of transducer may change the volume of mist that is within any specific region of the mist generator. Desirably, by routing the generated mist through the mist reservoir, which serves to equalise the distribution of exiting mist along the path A-A′ (FIG. 1A) any discrepancy will be minimised. It will be further appreciated that preferential direction of generated mist to specific portions of the distribution channel 122 could serve to assist in the random effect of a flame pattern that one would expect from a real fire. Operation of the transducers could also be arranged to have selected multiples of the provided transducers operating concurrently to increase the volume of mist generated at any one time to increase the flame effect simulated. Furthermore, by selectively activating one or more of the provided transducers the volume of mist generated from specific regions can be varied to differentiate the generated flame effect.

Desirably the mist generator will also include a level sensor 113 or switch that will be operable on the transducers to ensure that if the level of liquid within the mist generator during operation of the transducers falls below a predetermined level that operation of the transducers will be terminated to prevent damage to same. The level sensor or switch may also be coupled to an external visible indicator which is located within the fire housing so as to be visible to a user of the fire to advise when the level of the liquid has reached levels that require replenishing of the liquid reservoir. In the arrangement which is of an exemplary level switch arrangement that may be employed, a reed switch and floating magnet combination are used. Another arrangement could provide for valve control of the flow of liquid from the liquid reservoir to the mist generator to ensure that optimum levels are maintained within the generator—such control could be achieved through action of the level switch on a valve within the path defined between the liquid reservoir and mist generator.

It will be appreciated that control of the ultrasonic transducer and indeed the level switch requires control electronics. Within the context of a modular fabricated flame generator it is desirable that this control electronics be provided within a dedicated electronics housing portion 150, which could be separately formed from the other modular portions of the flame generator. This desirably provides a sealed housing which obviates the possibility of any liquid leakage from the other components of the flame generator affecting the operation of the electronics. Not only does this ensure that there is a single location where all electronics are housed, but in case of damage to any one electronics component this housing could be provided in a replaceable module which could be retrofitted into an existing flame generator by a home user. Furthermore, the location of all electronics in a single location provides for control of the distribution of heat away from the electronics components within the housing. Desirably this is provided by locating the electronics housing portion in a lower region of the flame generator and providing its base 151 or floor as a metallic or other suitable heat conducting material. In this way the heat generated by the electronic circuitry may be effectively distributed away from the circuitry by the heat sink provided by the floor.

As is shown in FIGS. 2B and 3B other high voltage electrical parts 260 (and by high voltage is meant mains voltage levels or greater) that are necessary for operation of the fire are desirably located within the housing in a region separate from the flame generator. This could optimally be in a rear portion of the fire housing and desirably at a height higher than that of the liquid levels within the flame generator such that any leakage will not ingress onto these electrical parts causing shorts or the like. The use of a separate chamber for these electrical parts could further prevent damage from liquid ingress.

Desirably each of the components that form the flame generator are provided in modular co-operable components which when assembled provide for fluid communication of a liquid initially provided in the liquid reservoir through an outlet thereof into the mist generator where a mist may be fabricated and then into the mist reservoir or distributor from which it may exit the flame generator. By providing each of the components as separate elements it is possible to easily assemble the respective components. By having a separate liquid reservoir it is possible to easily transport the reservoir by itself to a liquid source for replenishment. By having the distributor or reservoir formed separately to the mist generator it is possible to enable removal of the mist reservoir so as to gain access to the mist generator for example for cleaning or maintenance purposes. As all may then be mated together a compact flame generator may be provided that may easily be fitted within available room of a fire housing. Within the context of the teaching of this aspect of the present invention at least the mist generator and liquid reservoir are desirably separable from one another.

As part of the modular construction, the distributor or mist reservoir could be formed separately from the mist generator and removable therefrom to allow access to an interior portion of the mist generator 110 for periodic cleaning of the ultrasonic transducers located therein. It will be appreciated that as the transducer is in intimate contact with the liquid, that irrespective of any measures taken to ensure that the liquid is clean that there is a possibility over time of residue building up which may affect the operating performance of the transducer. As it is important that any mist that exits the flame generator exits it via predetermined locations, ideally only along the exit port of the distribution channel 122, it is important that any engagement between the individual components of the flame generator be through sealed fit. That can be provided through use of o-rings and the like provided between each of the mating surfaces along which fluid—either in the liquid or vapour phase will travel. Furthermore the present invention teaches that use of interference fits between coupling components will ensure a tight seal that obviates any unwanted leakages. This may be done in common or independently of chamfered mating surfaces between components.

To assist in mounting the flame generator to the fire housing the present invention teaches in one arrangement that the flame generator includes a shoe 160 or template which defines a mating location for the flame generator within the housing. The shoe is desirably fixed a priori to the housing and its location within the housing will define where the other components of the flame generator will be seated. The shoe in this arrangement defines a perimeter 161 having an outer 161A and an inner 161B surface. The footprint of the inner surface 161B defines the area within which the other components of the flame generator will be seated. As will be appreciated, the outlet from the flame generator determines where generated mist or vapour will exit and be introduced into the fire housing. To achieve the desired flame effects it is desirably that this is orientated correctly vis a vis respective light sources and/or fuel beds within the fire housing. By having a shoe or template that is permanently secured within the housing and with which the remainder of the flame generator may engage and mate, it is possible to ensure that each time the separate components of the flame generator are located back into the fire housing that the adopt their correct desired orientation. Desirably, the shoe will also include a heat sink 162 that will co-operate with the heat sink (where provided) of the electronics housing through one or more engagement surfaces 163 to dissipate the heat further away from the electronic components of the flame generator. This heat sink may be coupled to a portion of the fire housing to sink the heat further. In this way heat from the electronics are dissipated through the floor of the electronics housing to the shoe and further to the remainder of the housing.

Components of the flame generator that are intended to be in contact with a liquid are desirably manufactured from or treated with suitable anti-microbial agents to minimise any growth of unwanted microbes during the lifetime of the flame generator. Desirably these components are fabricated at least in part from a plastics which is advantageous in fabrication as it may be moulded or extruded and is also lightweight. By including an antimicrobial master batch additive within the polymer as part of the plastic formation process it is possible to inherently minimise microbe growth.

As was mentioned above the flame generator may also include a fan 130 or other mist agitating means. If provided as a fan it is desirable that the fan is provided within a fan housing 131 having an entrance port 132 external to the flame generator and from which it can draw air in and into contact with the mist to effect distribution of the mist out of the reservoir or distributor plate. Such a fan may direct the agitated air directly into the mist generator portion 110 of the flame generator or may alternatively or as well direct it towards the mist reservoir portion 120. This fan or indeed another fan provided adjacent to the flame generator within the lower portion of the fire housing could also be usefully employed in directing air currents upwardly into the fire housing and on which generated mist may be carried upwardly, which once illuminated will resemble flame effects. The fire housing could also include a fan provided in an upper region of the fire housing and configured to induce air currents upwardly through the housing on which the generated vapour or mist could be carried.

As shown in FIG. 2, specifically the cross section view of FIG. 2B, desirably the flame generator 100 is mounted within a fire housing 200 in a lower portion 205 thereof such that mist or other vapour effects which exit from the flame generator 100 pass upwardly into an interior portion 210 the housing of the fire where they will resemble flame effects. A fuel bed (not shown) will typically be also located in that interior portion, desirably provided on a shelf 211 or other mounting surface. A protective screen 212 fabricated from a glass or transparent plastics may be provided to the front of the interior portion 210 and will serve to protect interior portion from dust or other migrating dirt effects. It will be appreciated that the presence or otherwise of such as screen is not essential. At an upper 215 region of the fire, which in this context is an exemplary fire known within the art as an inset fire, a canopy 220 may be provided and within which a fan heater 225 may be used to provide additional heat forwardly of the fire 200. The canopy may incorporate a voice actuation control to provide for voice control of operation of the fire. Desirably if provided such a voice actuation module would be camouflaged to blend in with its mounting surface so as to disguise its presence.

The fan heater 225 may serve the additional benefit of drawing air upwardly from the interior portion 210 of the fire to provide for improved drafting effects in creating the flame effect pattern from the mist/vapour generated from the flame generator below. Heated air from the fan heater 225 will exit through a grill 226 visible to the front of the fire.

However within the context of the present teaching a primary generator of air currents within which the vapour is carried upwardly is one or more light sources 230 which are located in the lower portion 205 of the fire and which are orientated upwardly. In this arrangement the one or more light sources are directed onto the exiting mist from the flame generator to give the effects of flame. Desirably the light sources are orientated within the fire housing such that light output from them is orientated towards a front portion 206 of the fire housing. The colours of the lights sources may be varied by use of different coloured lights, the use of filters or the like or indeed by using electronically controlled light sources whose output changes with changing control signals. To achieve the best flame pattern it has been found by the present inventors that the light sources are arranged behind the exiting mist from the flame generator such that they operably shine through the exiting mist when seen from the front 206 of the fire.

A fire housing incorporating such lights and a flame generator may desirably include an air intake vent 240 (shown in FIG. 2B as being to the front of the fire and below a fret portion 241 of the fire). It is desirable, although not essential, that air entering from the air intake vent enters into the fire in a region located below the lights so as to promote generation of air currents upwardly within the fire housing which will assist in conveying the exiting mist from the flame generator upwardly within the fire housing. In a stove type construction such as that shown in FIG. 3A, one or more vents 364 may be provided in an upper front portion of the fire to assist in generation of convective currents within the interior volume of the stove housing so as to convey the generated vapour towards the front of the stove where they are visible as flames through the doors 363 of the stove.

It is also possible to top light the flame pattern so as to change the effect of the generated flame pattern using a light 235 provided in the upper region of the fire and configured to direct light downwardly onto the fuel bed. It will be appreciated that the addition of extra illumination may serve to hide some of the flame pattern generated and so if provided it is desirable that the use of the top light be user controllable so that the user can determine the desired effect. To accentuate the generated flame effect it is desirable if a rear 208 and side walls of the interior portion defining the flame pattern generating region be darkly coloured to provide contrast with the coloured elements that define the flame pattern.

It will be appreciated that the flame generator of the present invention differs somewhat from flame effect generators previously known for use in the context of electric fires. In such previous arrangements a simple mechanical arrangement was used to effect a simulation of flame effects be that through the use of moveable ribbons, rotating drums or the like. In those prior art arrangements once the fire was manufactured, the user of the fire had no regular requirement to gain access to the interior portion of the fire. In cases where it was necessary to change a bulb or the like it was known to for example remove the fuel bed and access the light from above. In the context of a flame generator in accordance with the teaching of the present invention regular access, if only to get access to the liquid reservoir 140 is necessary. To provide for ease of access to the components of the flame generator the present invention provides for at least one of the mounted flame generator and fire housing be moveable relative to the other. For example as shown in FIG. 2, the flame generator could be provided on a moveable slide or tray 250 from which it may be slid into and out of the interior portion of the fire housing. To gain access to the flame generator at least a part of the front portion of the housing 240 could be removed and the flame generator could be slid forwardly of the fire to achieve the necessary inspection. Once out of the fire the individual components could be separated. For example the liquid reservoir 140 could be taken off to refill it. In the arrangement shown the shoe portion of the flame generator is fixed to a moveable shelf 251, the shelf being moveable relative to the housing. In another arrangement the shoe could be provided on tracks that allow it to move along the tracks and out of the housing. In both arrangements the flame generator is moveable in a controlled predetermined fashion in and out of the fire housing. It will be noted that the part that will require removal most often, the liquid reservoir 140 is desirably provided to the front of the fire housing where it can be easily accessed once the interior volume of the fire housing is visible.

In another arrangement which could be used independently or as well as the moveable slide, a portion of the fire housing could be moveable relative to another portion of the fire housing to provide access to an interior portion of the fire. Such movement could for example be achieved by having a hinged or pivot arrangement between the two portions of the fire housing that are moveable relative to one another. For example, while not shown, the fret 240 could be hinged to the remainder of the housing to enable it to be moved up and away from its normal position over the flame generator 100 so as to allow access to the flame generator. In this way the flame generator could then be accessed through the available aperture or could indeed use the moveable track discussed above to enable it to be subsequently taken out of the interior portion of the fire housing.

It is desirable within the context of a fire provided within the teaching of the present invention that any generated flame pattern defined by interaction between generated mist and light sources within the fire housing will occupy a central dominant portion of the fire. To ensure that the generated flame effects are visible to a viewer to the front of the fire the light sources could be directed forwardly and upwardly such that the heated air currents resultant from the light sources and on which the mist is conveyed are preferentially directed towards the front and top of the fire housing. This is particularly advantageous in the context of a stove fire arrangement 300 such as that shown in FIG. 3. Where components are similar or analogous to those described previously with reference to FIGS. 1 and 2 the same reference numeral will be used or the first integer will be changed.

In FIG. 3, the generated flame pattern is within a defined enclosed volume of the stove fire housing. This volume is within the space defined between two closed doors 361, 362 each of which have an at least partially transparent surface 363 provided therein to allow a user to view the interior portion of the stove. In this stove arrangement the light source 330 is arranged to point upwardly and towards the front portion 306 of the stove. In this way vapour exiting the mist reservoir 122 will be entrained in the heated air from the light source 330 and conveyed forwardly and upwardly. By having a plurality of light sources arranged parallel to the front doors of the stove a distribution of flame patterns will be generated across the interior portion 310 of the stove.

To gain access to the flame generator a front door 340—resembling the ash tray door of a conventional stove is opened and the flame generator may be accessed. This could also be provided on a moveable platform to enable it to be moved outwardly in a controlled fashion from the interior portion of the fire housing.

It will be appreciated that a flame generator such as that employed within the context of the present invention advantageously uses an interaction between light and generated mist or other vapours in an entrained air current to create flame effects. To further improve the illusion of the flame effects it is possible to address some of the other sensory expectations of a user watching a real fire. For example by providing an essence having the properties associated with a burning fire—for example burning logs—into the liquid reservoir any created smells will be conveyed in the heated air currents within which the exiting mist is entrained and carried from the fire where they will be experienced by the user. Other arrangements for generating smells could equally be employed within the context of the present invention.

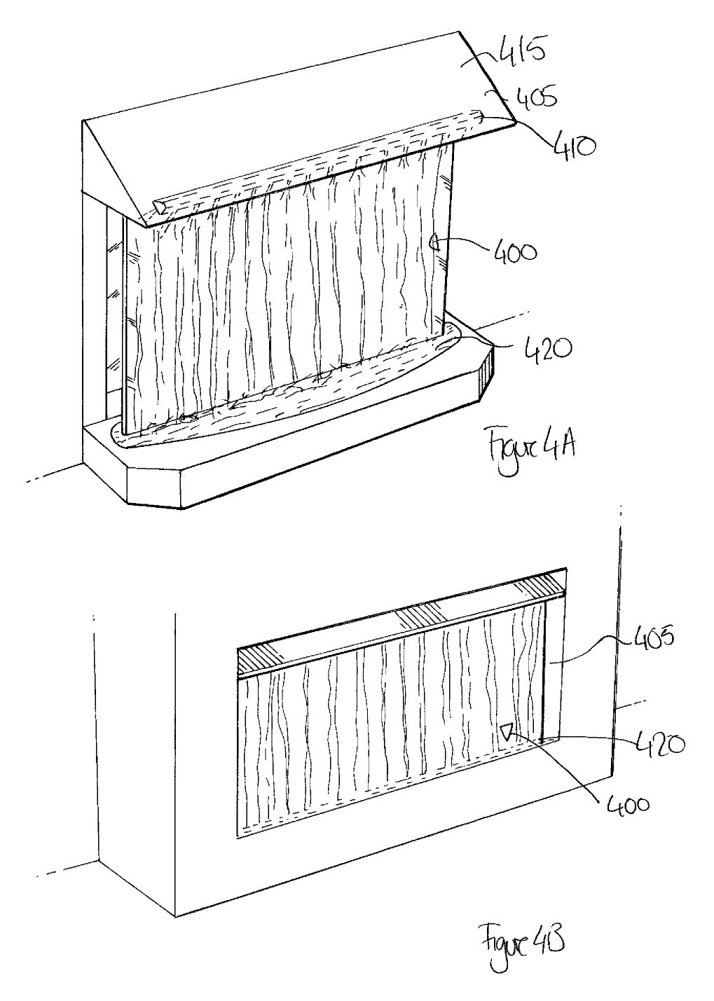

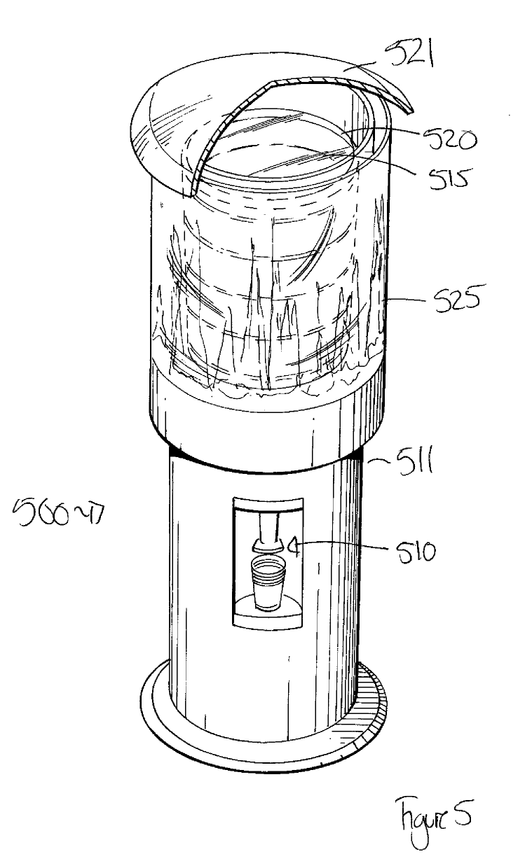

It will be appreciated that a fire such as that described heretofore employs a liquid reservoir to provide liquid for use in simulation of flame effects. By having a reservoir within a fire housing it is possible to provide other effects within the fire. One example of such a secondary purpose as shown in FIG. 4, is to provide a second water based feature such as waterfall 400 within the fire housing 405. The liquid from the reservoir which is used to generate the flame effects could be used to provide liquid for the waterfall. By allowing the water to exit from a manifold 410 located parallel to the front of the fire—typically in a canopy 415 or other upper region of the fire, the waterfall could be arranged to fall in front of the flame generating region within the fire. In such circumstances the operation of the waterfall could be used as an alternative to the operation of the fire or indeed could be used to enhance the viewing experience of the flame effects generated behind the waterfall. As the water falls downwardly it may be collected in a reservoir 420 where it can be used again in a recycled fashion. Such a reservoir could also provide an easy inlet for the user to refill the liquid for the flame generator—indeed the modular type flame generator heretofore described need not be employed in such an arrangement.

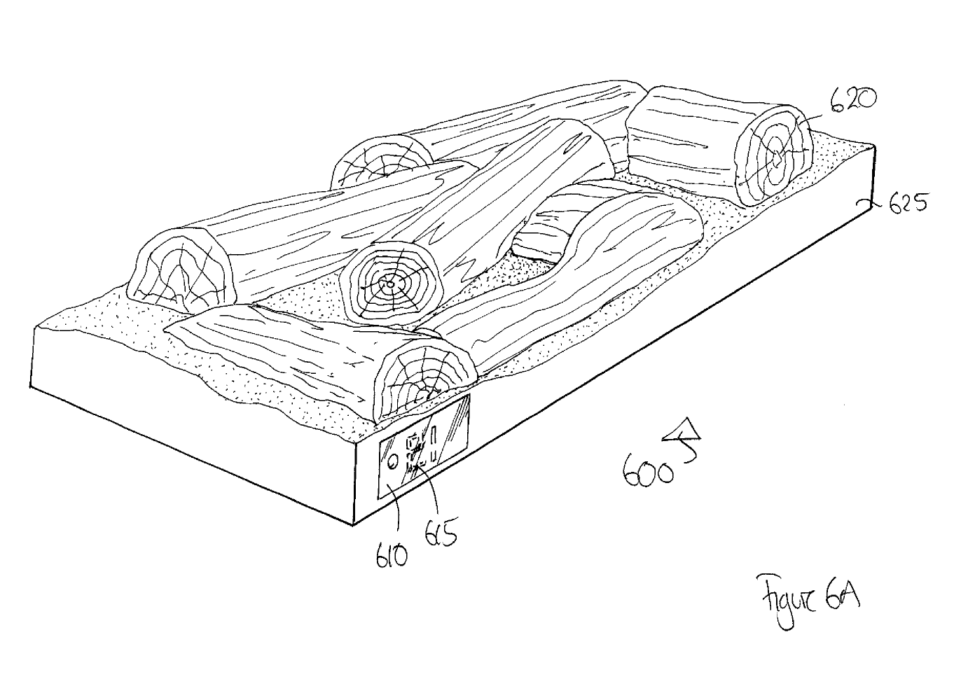

FIG. 5 shows another fire that uses the water reservoir for the flame generator in a dual mode. In this arrangement an integrated fire and water dispenser 500 is provided. Similarly to other known water dispensers, the fire is provided as a column structure with a tap 510 provided in a lower region 511 of the column. A water reservoir 515 which is removable from the fire is top mounted onto the column and provides liquid to the tap under gravity. The water reservoir is receivable within an inner volume 520—accessed through a hatch 521 at the top of the fire—of the fire defined by a flame generating region 525 encapsulating the reservoir 515 when it is properly received and seated. In this way once the reservoir is located within the fire, it is hidden by the flame generating region 525. By using a flame generator such as that described before, or any other flame generator that enables provision of an arcuate flame pattern that can extend about a circumferential path, it is possible to generate flame which are visible from all sides of the fire. The other components of the flame generator such as the lights and mist generators could be located in the lower region 511 of the fire. It will be appreciated that such an integrated water dispenser and fire may not required generation of flame effects through generated vapour. In such an arrangement the flame effects are desirably still generated on a screen or other flame generating region located about the reservoir for the water dispenser such that the water reservoir when received is not visible to the user.

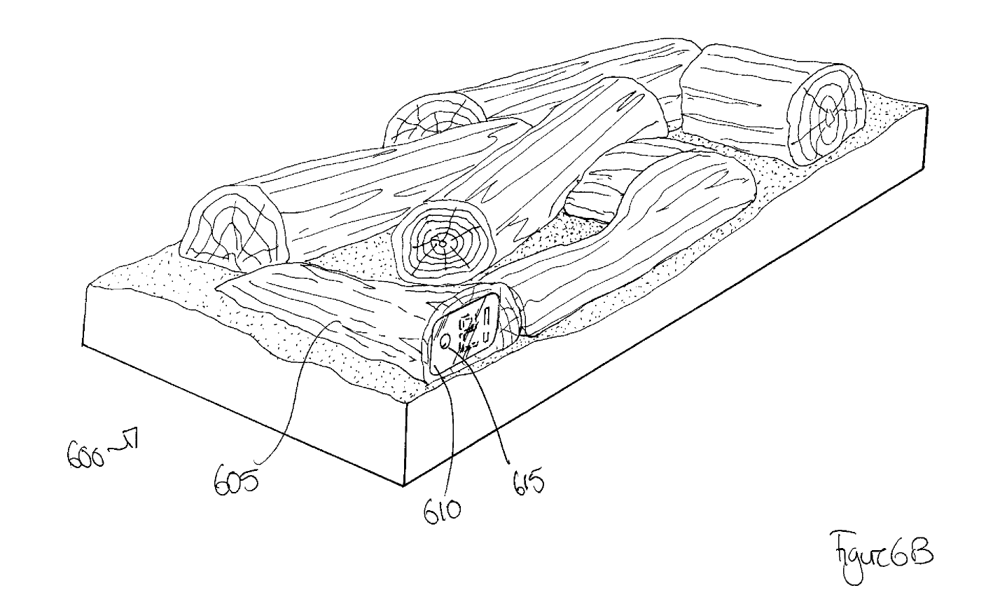

As was mentioned above, desirably a fire housing incorporating such a flame generator will also include a fuel bed which provides for the simulation of fuel bed effects as would be found in a traditional fire. There are many way to fabricate such fuel beds. One way which may be particularly useful within the context of the present invention although it could be used with other types of electric fire is to provide the fuel bed from a plurality of fuel bed elements which are mounted relative to one another to resemble a stacked fuel bed. Such a fuel bed 600 is shown in FIGS. 6A and 6B. As shown in FIG. 6B, desirably a fuel bed element 605 that will ultimately be located towards the front of the fuel bed may include a pocket—defined within an interior volume of the fuel bed element and in the arrangement of FIG. 6B behind a window 610. Within the pocket may be received a light source 615 such as an LED indicator or the like and/or a receiver for remote control operation of the fire. By discretely locating such devices within a fuel bed element it is possible to control the fire and/or obtain information regarding the status of the fire without having to modify the fire housing to provide such mountings. As control electronics for such light sources/receivers could be suitably located within a lower portion of the fire—perhaps beside the flame generator if provided, then the use of the fuel bed element with a pocket is particularly advantageous as the fuel bed is immediately adjacent the location of the control electronics. In the arrangement of FIG. 6A moulded individual fuel bed elements 620 are stacked on a support platform 625 that includes the pocket within which the electronics may be stored. It will be appreciated that the term “fuel bed” within this context is therefore intended to include both individual fuel elements and the combined bed upon which they may be mounted.

It will be appreciated that what has been described herein are exemplary arrangements or aspects of the teaching of the present invention. It will be understood from that described that the invention relates generally to electric fires and particularly to electric fires that simulate flame effects. In a first aspect a flame effect generator that may be used within the context of electric fires to generate flame effects that are viewable within the fire was described. In another aspect also a fire having a reservoir for use in generation of flame effects which is also used for secondary features of the fire was described. The invention also provided in a further aspect an integrated water cooler and electric fire. In yet a further aspect a fuel bed with a pocket for receiving one or more electronic controls was provided. Yet a further aspect provided a voice actuated electric fire. It will be appreciated that a single fire could include one or more of these aspects used in combination with one another. Other fires provided in accordance with the teaching of the invention could selectively include one or more of these aspects. To this end it will be appreciated that where features or integers were described with reference to any one figure that these feature or integers could be interchanged with or replaced by other elements including those described in another figure without departing from the teaching of the present invention. These and other features of the invention will be apparent to the person skilled in the art.

The words comprises/comprising when used in this specification are to specify the presence of stated features, integers, steps or components but does not preclude the presence or addition of one or more other features, integers, steps, components or groups thereof.

1. An electric fire flame effect generator for use in an electric fire, the flame effect generator including:
a. a mist generator wherein a mist may be generated from a liquid,
b. a separately formed mist reservoir mateable with the mist generator and to which generated mist may pass, the mist reservoir having an outlet from which mist may then be allowed to pass upwardly into the fire within which the generator is located, and
c. a liquid reservoir for providing liquid to the mist generator, and
d. wherein the flame effect generator is provided in modular construction with each of the mist generator and liquid reservoir being distinct separate components which may be coupled together to operably define a fluid path, in appropriate liquid or gaseous form from the liquid reservoir through the generator and into the mist reservoir.

2. A flame effect generator for use with an electric fire for simulating flame effects, the flame effect generator comprising a mist generator in fluid communication with a liquid reservoir, the flame effect generator further comprising a separate shoe with which the mist generator cooperates and engages with, the shoe being configured for permanent attachment to a fire housing so as to provide for accurate alignment of the flame effect generator within a housing of the electric fire.

3. (canceled)

4. The flame effect generator of claim 1 wherein the generator on assembly provides a sealed unit through which generated mist may only exit via a defined exit provided in the mist reservoir.

5. The flame effect generator of claim 2 wherein the liquid reservoir is removable from the flame generator.

6. The flame effect generator of claim 1 wherein the mist generator uses a liquid from which the mist is generated through agitation of the liquid by an ultrasonic generator.

7. The flame effect generator of claim 1 wherein the liquid reservoir is coupled to the mist generator via a top mount arrangement, control of flow of liquid from the liquid reservoir into the mist generator being effected by use of a valve arrangement which enables water flow once the reservoir is seated on the mist generator.

8. The flame effect generator of claim 7 wherein the mist generator includes a level indicator or switch that controls operation of the mist generator to times when a predetermined volume of liquid is provided within the mist generator.

9. The flame effect generator of claim 7 including a valve operable to control flow of liquid between the liquid reservoir and the mist generator.

10. The flame effect generator of claim 1 wherein the mist generator includes a level indicator coupled to an external visible indicator provided on an exterior surface of the fire within which the flame effect generator is used so as to be visible to a user of the fire to advise when the level of the liquid has reached levels that require replenishing of the liquid reservoir.

11. The flame effect generator of claim 1 wherein the mist generator comprises two or more transducers configured to be independently operable.

12. The flame effect generator of claim 11 wherein the transducers are operable in a sequential fashion such that activation of selected ones of the provided transducers in a sequence provides for deactivation of selected others of the transducers so as to prolong the lifetime operation of the flame generator.

13. The flame effect generator of claim 11 wherein concurrent operation of the multiple transducers is used to generate additional flame effects as desired.

14-16. (canceled)

17. The flame effect generator of claim 1 wherein each of the components that form the flame effect generator are provided in modular co-operable components which when assembled provide for fluid communication of a liquid initially provided in the liquid reservoir through an outlet thereof into the mist generator where a mist may be fabricated and then into a mist reservoir or distributor from which it may exit the flame generator.

18. The flame effect generator of claim 1 further comprising a shoe or template locatable separately into the fire with which the flame effect generator is used and which defines a mating location for the flame effect generator when received within that fire.

19. The flame effect generator of claim 18 wherein the shoe includes a heat sink which provides for dissipation of heat away from electronic components of the flame generator.

20. The flame effect generator of claim 1 wherein components of the flame effect generator that are intended to be in contact with a liquid are manufactured from or treated with suitable anti-microbial agents to minimise any growth of unwanted microbes during the lifetime of the flame generator.

21. The flame effect generator of claim 1 including a fan or other mist agitator which provides for assisted distribution of generated mist out of the flame generator.

22. An electric fire including a flame effect generator as claimed in claim 1, the flame effect generator being mounted within a fire housing in a lower portion thereof such that mist or other vapour effects which exit from the flame effect generator pass upwardly into the housing of the fire where they will resemble flame effects.

23. The fire of claim 22 wherein at least one of the mounted flame effect generator and fire housing are moveable relative to the other.

24. The fire of claim 23 wherein the flame effect generator is provided on a moveable slide or tray on which it may be conveyed into and out of an interior portion of the fire housing.

25. The fire of claim 23 wherein a portion of the fire housing is moveable relative to another portion of the fire housing to provide access to an interior portion of the fire.

26. The fire of claim 25 wherein the fire provides a hinged or pivot arrangement between the two portions of the fire housing that are moveable relative to one another.

27. The fire of claim 22 further comprising one or more light sources which may be directed onto the exiting mist from the flame effect generator to give the effects of flame.

28. The fire of claim 27 wherein the light sources are orientated within the fire housing such that light output from them is orientated towards the front of the fire housing.

29. The fire of claim 22 including one or more vents to assist in generation of air currents within the fire housing.

30. The fire of claim 27 wherein the vents are located in at least one of upper or lower surfaces of the fire housing.

31. The fire of claim 27 wherein the colours of the lights sources may be varied by use of different coloured lights, the use of filters or the like or by using electronically controlled light sources whose output changes with changing control signals.

32. The fire of claim 27 wherein the light sources are arranged so as to be behind the exiting mist from the flame effect generator such that they operably shine through the exiting mist when seen from the front of the fire.

33. The fire of claim 22 including a forced convection means provided in an upper and/or lower portion of the fire housing to induce air currents upwardly within the fire housing.

34-48. (canceled)
